(19) United States
(12) Patent Application Publication
(10) Pub. No.: US 2020/0249809 A1
(43) Pub. Date: Aug. 6, 2020

(54) DISPLAYING MESSAGES BASED ON IMPORTANCE

(71) Applicant: International Business Machines Corporation, Armonk, NY (US)

(72) Inventors: Yin Xia, Beijing (CN); Dong Chen, Beijing (CN); Huai Ying Xia, Beijing (CN); Ya Ju Yan, Beijing (CN); Li Hong Qi, Beijing (CN); Zhou Kun, Beijing (CN)

(21) Appl. No.: 16/267,984

(22) Filed: Feb. 5, 2019

(51) Int. Cl. G06F 3/0485; G06F 3/0481

(52) U.S. Cl. CPC G06F 3/0485; G06F 3/0481

(57) ABSTRACT

Embodiments of the present invention include computer-implemented methods, computer systems, and computer program products for displaying messages based on categories. According to an embodiment, a computer-implemented method comprises: receiving, by a device operatively coupled to one or more processors, a request for displaying messages for a user based on categories; calculating, by the device, an importance score of each of the messages to the user; classifying, by the device, the messages into the categories based on calculated importance scores of the messages; and displaying, by the device, the messages for the user based on the categories.

### BACKGROUND

One or more embodiments relates to the field of message processing, and more specifically, to displaying messages based on categories related to message importance.

### SUMMARY

Currently, users usually view messages from other users in a social network application, such as Wechat and the like, based on senders of the messages, message communities, or respective receiving time of the messages. Example embodiments described herein comprise computer-implemented methods, computer systems, and computer program products for displaying messages based on categories related to message importance.

In an aspect, a computer-implemented method is disclosed. According to the computer-implemented method, the computer-implemented method comprises: receiving, by a device operatively coupled to one or more processors, a request for displaying messages for a user based on categories; calculating, by the device, an importance score of each of the messages to the user; classifying, by the device, the messages into the categories based on calculated importance scores of the messages; and displaying, by the device, the messages for the user based on the categories.

In another aspect, a computer system is disclosed. The computer system may comprise: a memory that stores computer executable components; and a processing unit operably coupled to the memory, and that executes the computer executable components stored in the memory. The computer executable components comprise: at least one computer-executable component that: receives a request for displaying messages for a user based on categories; calculates an importance score of each message of the messages to the user; classifies the messages into the categories based on calculated importance scores of the messages; and displays the messages for the user based on the categories.

In yet another aspect, a computer program product is disclosed. The computer program product comprises a computer readable storage medium having program instructions embodied therewith. When executed on one or more processors, the instructions may cause the one or more processors to perform the above computer-implemented method.

It is to be understood that the summary is not intended to identify key or essential features of embodiments of the present invention, nor is it intended to be used to limit the scope of the present disclosure. Other features of the present disclosure will become easily comprehensible through the description below.

### BRIEF DESCRIPTION OF THE DRAWINGS

Through the more detailed description of some embodiments of the present invention in the accompanying drawings, the above and other objects, features and advantages of the present disclosure will become more apparent, wherein the same reference generally refers to the same components in the embodiments of the present invention.

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 depicts a flow diagram illustrating a method 400 for displaying messages to a user based on categories related to message importance to the user according to an embodiment of the present invention; and

FIG. 5A and FIG. 5B show exemplary user interfaces for a user named Zhang San according to an embodiment of the present invention.

Throughout the drawings, the same or similar reference numerals represent the same or similar elements.

### DETAILED DESCRIPTION

Some embodiments will be described in more detail with reference to the accompanying drawings, in which the embodiments of the present invention have been illustrated. However, various embodiments can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

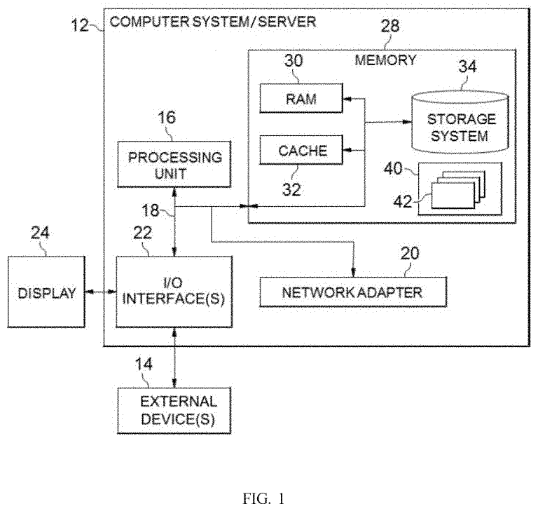

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

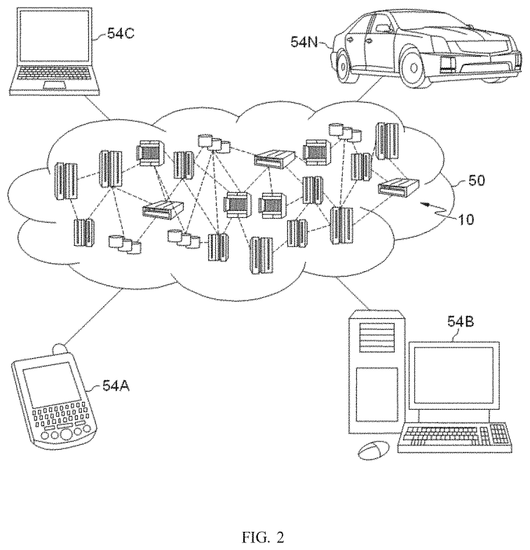

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

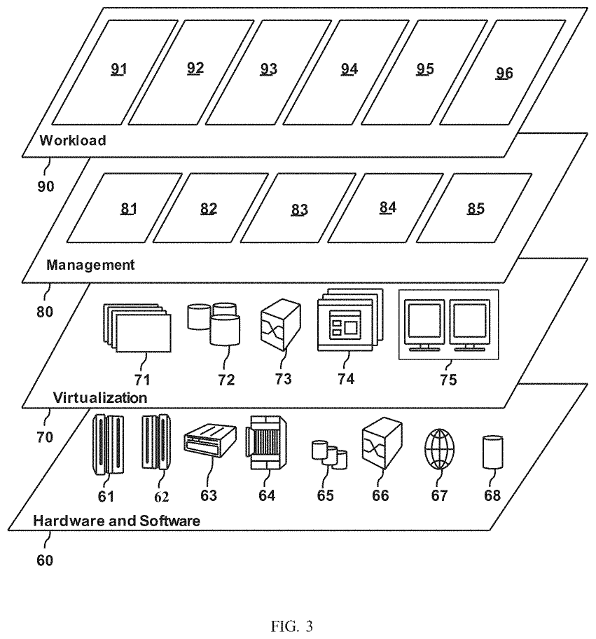

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and messages processing 96.

Currently, if a mass of messages are received in a social network application, the messages are usually displayed based on names of message senders, community names of message communities, and the like. And if a mass of messages are received during chatting in a message community or during chatting with another user, the messages are usually displayed based on respective delivery time of the messages. In a scenario, if hundreds of messages from a single source, such as a message community, are received when a user accesses the social network application, the several hundred messages are displayed in the order of their respective delivery time. And it is very likely for a user to miss some messages which may be important for the user when the user quickly scrolls the screen with the user's finger. Thus, there is a need to display these messages based on the message importance to the user.

The embodiments of the present invention provide a solution for displaying messages to a user based on categories related to message importance to the user.

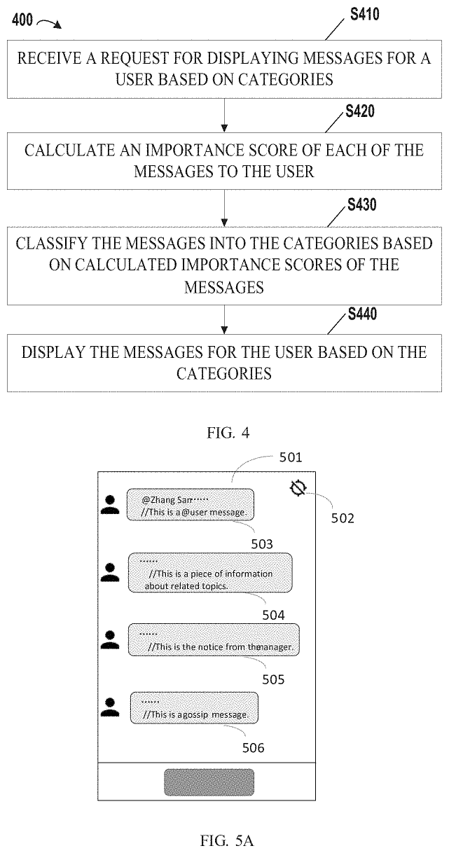

FIG. 4 depicts a flow diagram illustrating a method 400 for displaying messages to a user based on categories related to message importance to the user according to an embodiment of the present invention. The messages can include all messages during chatting with friends or during chatting in message communities in a preset period, such as all messages sent by the user, all received messages, all new messages received after the latest viewing by the user, or all new messages received during chatting in a message community or during chatting with a friend after the latest viewing by the user, and the like. Referring to FIG. 4, the process can begin at step S410 in which a request for displaying messages for a user based on categories related to message importance to the user can be received. And the method 400 then can proceed to step S420 in which an importance score of each message of the messages to the user can be calculated. And at step S430, the messages can be classified into the categories based on respective calculated importance score of the messages. And at step S440, the messages can be displayed for the user based on the categories. Then the process of displaying messages to a user based on categories related to message importance to the user, as part of method 400, is ended.

In some embodiments, the importance score of a message can be calculated using at least one of the following factors: relationship between a sender of the message and the user, contents of the message, preferences of the user, properties of the message, and contexts of the message, etc. And respective thresholds of these factors can be configured. For a factor, different values can also be configured to indicate how important the message is. Then the importance score of the message can be calculated based on these configured values. Each value can be in a range of 0-10, for example.

For example, 4 values can be configured for the factor of relationship between a sender of the message and the user, such as a value can be configured for a message from a sender belonging to one of four kinds of senders. And 2 values can be configured for the factor of contents of the message, such as a value for a message in which @user is included and a value for a message in which @user is not included. And several values can be configured for the factor of preferences of the user, such as a value for a message with m keywords matched with n (m<=n) keywords defined in the preferences of the user, and each time the number of matched keywords is reduced, the value is reduced until the value reaches 0. And 2 values can be configured for the factor of properties of the message, such as a value for a message with working time as message delivery time in a working message community, and a value for a message with working location as message delivery location in the working message community. And several values can be configured for the factor of contents of the message, such as a value for a message related to a question from the user in the user's previous message with 1 keyword matched, a value for a message with 2 keywords matched, etc. And for each additional matching keyword, the value is increased until the value reaches corresponding threshold of the factor of contents of the message.

From the above description, it can be understood that the importance score of a message can be calculated based on technologies of semantic analysis, keyword extraction, context analysis, relationship analysis, preference analysis and the like. All details in these technologies are omitted here, and it is assumed that the analysis results have been obtained.

In some embodiments, it is assumed that the values of a factor are equal to or less than the threshold of the factor. And if the user selects one or more factors, an importance score of a message can be calculated by adding up respective values of each configured factor.

In an example, it is assumed that the user selects 5 above-mentioned factors. The thresholds for these factors, e.g. relationship between a sender of the message and the user, preferences of the user, contents of the message, properties of the message, contexts of the message, are configured to be 5, 8, 8, 2, and 6 respectively. Suppose that it is configured in the example that values for the factor of relationship between a sender of the message and the user in a working message community are 5 for a message from a sender belonging to a first kind of senders, 4 for a message from a sender belonging to a second kind of senders, 3 for a message from a sender belonging to a third kind of senders, and 2 for a message from a sender belonging to a forth kind of senders. And the user can configure which kind of senders each person in the user's contact book belongs to. And suppose that it is configured in the example that values for the factor of contents of the message are 8 for a message in which @user is included, and 0 for a message in which @user is not included. Also suppose that it is configured in the example that values for the factor of preferences of the user are 8 for a message with 4 keywords matched with 4 keywords defined in the preferences of the user, and each time a matching keyword is reduced, the value is reduced by two, for example. Still suppose that it is configured in the example that values for the factor of properties of the message are 1 for a message with working time as message delivery time in a working message community, and 1 for a message with working location as message delivery location in the working message community. Yet suppose that it is configured in the example that values for the factor of contents of the message are 2 for a message related to a question from the user in the user's previous message with 1 keyword matched. And for each additional matching keyword, the value is increased by one until the value reaches its maximum value. Then the importance score of a message, not including @user (value is 0) and with 1 keyword matched with one of 4 keywords defined in the preferences of the user (value is 2), and received from a sender belonging to the first kind of senders in a message community (value is 5) and with working time as message delivery time (value is 1), and related to a question from the user in the user's previous message with 2 keyword matched (value is 4), can be calculated as: 0+2+5+1+4=12.

In some embodiments, the importance score of the message can be calculated by adding up each multiplication of a weight of each configured factor and a value of each configured factor.

For example, suppose in a message community that it is configured in an example that weights of two factors including relationship between a sender of the message and the user and contents of the message are 0.2, 0.8 respectively. And also suppose that it is configured in the example values for the factor of relationship between a sender of the message and the user are 4 for a message from a sender belonging to the first kind of senders, 3 for a message from a sender belonging to the second kind of senders, 2 for a message from a sender belonging to the third kind of senders, and 1 for a message from a sender belonging to the forth kind of senders. And also suppose that it is configured in the example values for the factor of contents of the message are 2 for a message in which @user is included, and 0 for a message in which @user is not included. Then an importance score of a message from a sender belonging to the first kind of senders including @user can be calculated as: 0.2*4+0.8*2=2.4.

It can be understood that other methods for calculating an importance score of a message can also be used.

For all messages, which may be from the user, from different message community or different friends, and the like, their importance scores can be calculated based on the values of these factors and/or the weights of these factors.

It can be understood that the user can define more or less factors than the above examples for all received messages. It also can be understood that the user may configure different factors in different message communities. For example, the factor of relationship between a sender of the message and the user can be cancelled in a family message community because the user may believe that all senders are equally important to the user. And the four factors including factors of relationship between a sender of the message, contents of the message, properties of the message, and contexts of the message, can be used in a working message community. It also can be understood that the user may configure different values for different factor in different message communities.

And referring back to FIG. 4, at step S430, the messages can be classified into the categories based on calculated importance scores of the messages. The user can set different importance score ranges for different categories. In an example, the user may set 3 categories related to message importance to the user, they are “important messages” whose message scores are equal to or more than 6, “ordinary messages” whose message scores are equal to or more than 3 and less than 6, “unimportant messages” whose message score are less than 3. Those skilled in the art can understand that more or less categories can be set and respective ranges of importance scores can be set accordingly.

And at step S440, the messages can be displayed for the user based on the categories. In some embodiments, the messages are still displayed in the order of respective receiving time of the messages, but messages in different categories are displayed in different background shadows, in different background color, in different font color, in different fonts, or in different font sizes, etc. For example, the messages in the category of “important messages” are displayed in yellow background color so that these important messages can not be missed by the user.

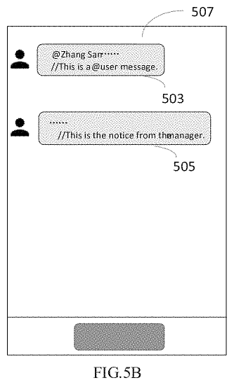

In some embodiments, names of the categories for the user can be displayed to the user for selection, and then in response to detecting that a category is selected by the user, messages in the category can be displayed to the user. FIG. 5A and FIG. 5B show two exemplary user interfaces for a user named Zhang San according to an embodiment of the present invention, in which 501 indicates all new messages 503-506 received by Zhang San in a team message community including Zhang San in the order of receiving time of these messages, and importance scores of messages 503-506 are calculated as 8, 2, 5, 0 respectively. Zhang San has set 3 categories related to message importance, they are “important messages” in which scores of the messages are equal to or lager than 5, “ordinary messages” in which scores of the messages are equal to or lager than 2 and smaller than 5, and “unimportant messages” in which scores of the messages are smaller than 2. When Zhang San presses the button 502, a drop-down menu or the like (which is not shown in FIG. 5A and FIG. 5B) comprising three selections, e.g. “important messages”, “ordinary messages” and “unimportant messages”, is displayed for user selection. If Zhang San selects “important messages”, interface 507 can be displayed to her, in which only messages 503 and 505 are included. And if Zhang San selects “ordinary messages”, another interface, which is not shown in FIG. 5A and FIG. 5B, can be displayed to her, in which only messages 504 is included. And if Zhang San selects “unimportant messages”, another interface, which is not shown in FIG. 5A and FIG. 5B, can be displayed to her, in which only messages 506 is included. It can be understood that all new messages 503-506 can be received from different sources, such as different message communities, different friends, and the like. And these kinds of messages can also be displayed based on categories related to message importance to the user.

In some embodiments, messages in a category can be displayed in the order of importance scores of the messages in the category. For example, if Zhang San configures this option, the importance score of message 503, which is equal to 8, is more than the importance score of message 505, which is equal to 5, thus message 503 can be displayed first in the interface 507. And in some embodiments, messages in a category can be displayed in the order of receiving time of the messages in the category. Still in the above example, if Zhang San configures this option, and message 503 is received earlier than message 505, thus message 503 can be displayed first in the interface 507.

In some embodiments, if hundreds of new messages are received in a message community and are requested to be displayed based on categories related to message importance to the user, the messages in a category can be displayed by automatically scrolling the screen or scrolling the screen triggered by an action of the user, such as finger pulling up, double touched screen, and the like. In this invention, different scrolling speeds for different categories can be configured automatically or by the user, and the messages in a category can be displayed using a configured scrolling speed of the category in response to receiving a scrolling request from the user. In some embodiments, the user can configure different scrolling speeds for different categories, for example, the scrolling speeds for messages in the category of “important messages”, “ordinary messages”, and “unimportant messages” are 3, 5, 9 respectively, in other words, the messages in the category of “important messages” can be scrolled slowly so that they can be viewed by the user clearly, while the messages in the category of “unimportant messages” can be scrolled quickly so that they can be skimmed by the user rapidly. In another example, the user can configure a base scrolling speed for the messages in the category of “unimportant messages”, and scrolling speed for the messages in the category of “important messages” and “ordinary messages” can be one third and half of the base scrolling speed respectively. Those skilled in the art can use other methods to configure different scrolling speeds for messages in different categories.

In some embodiments, if existing messages have been displayed for the user based on categories related to message importance to the user, and a new message is received, an importance score of the new message can be calculated first and then the new message can classified into one of the categories based on the importance score of the new message. Thus the new message can also be displayed for the user based on categories related to message importance to the user together with the existing messages. In some embodiments, the new message can be displayed together with the other messages in a category in the order of receiving time of each message of the messages in the category or in the order of importance scores of the messages in the category.

Based on the above example, it is easily for those skilled in the art to think out the other examples, which are not described in detail in this disclosure.

It should be noted that the processing of displaying messages based on categories related to message importance according to embodiments of this disclosure could be implemented by computer system/server 12 of FIG. 1.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a device operatively coupled to one or more processors, a request for displaying messages for a user based on categories;
calculating, by the device, an importance score of each of the messages to the user;
classifying, by the device, the messages into the categories based on calculated importance scores of the messages; and
displaying, by the device, the messages for the user based on the categories.

2. The computer-implemented method of claim 1, wherein the importance score of a message is calculated based on at least one of the following: relationship between a sender of the message and the user, preferences of the user, contents of the message, properties of the message or contexts of the message.

3. The computer-implemented method of claim 1, wherein the displaying the messages for the user based on the categories comprises:
displaying, by the device, names of the categories for the user; and
displaying, by the device, messages in a category in response to detecting that the category is selected by the user.

4. The computer-implemented method of claim 3, wherein the displaying the messages for the user based on the categories further comprises:
configuring, by the device, different scrolling speeds for different categories, wherein the displaying the messages in a category in response to detecting the category is selected by the user further comprises:
scrolling, by the device, the messages in the category using a configured scrolling speed of the category in response to receiving a scrolling request from the user.

5. The computer-implemented method of claim 3, wherein the displaying the messages in a category comprises:
displaying, by the device, the messages in the category in the order of the importance scores of the messages in the category.

6. The computer-implemented method of claim 3, further comprising:
receiving, by the device, a new message;
calculating, by the device, an importance score of the new message;
classifying, by the device, the new message into one of the categories based on the importance score of the new message.

7. The computer-implemented method of claim 1, wherein displaying the messages for the user based on the categories comprises:
displaying, by the device, the messages in different categories using at least one of the following: different background shadows, different background colors, different font colors, different fonts or different font sizes.

8. A system, comprising:
a memory that stores computer executable components; and
a processing unit operably coupled to the memory, and that executes the computer executable components stored in the memory, wherein the computer executable components comprise:
at least one computer-executable component that:
receives a request for displaying messages for a user based on categories;
calculates an importance score of each message of the messages to the user;
classifies the messages into the categories based on calculated importance scores of the messages; and
displays the messages for the user based on the categories.

9. The computer system of claim 8, wherein the importance score of a message is calculated based on at least one of the following: relationship between a sender of the message and the user, preferences of the user, contents of the message, properties of the message, or contexts of the message.

10. The computer system of claim 8, wherein the displaying the messages for the user based on the categories comprises:
displaying, by one or more processors, names of the categories for the user; and
displaying, by one or more processors, messages in a category in response to detecting that the category is selected by the user.

11. The computer system of claim 10, wherein the displaying the messages for the user based on the categories further comprises:
configuring, by one or more processors, different scrolling speeds for different categories, wherein the displaying the messages in a category in response to detecting the category is selected by the user further comprises: scrolling, by one or more processors, the messages in the category using a configured scrolling speed of the category in response to receiving a scrolling request from the user.

12. The computer system of claim 10, wherein the displaying the messages in a category comprises:
displaying, by one or more processors, the messages in the category in the order of the importance scores of the messages in the category.

13. The computer system of claim 10, the method further comprising:
receiving, by one or more processors, a new message;
calculating, by one or more processors, an importance score of the new message; and
classifying, by one or more processors, the new message into one of the categories based on the importance score of the new message.

14. The computer system of claim 8, wherein displaying the messages for the user based on the categories comprises:
displaying, by one or more processors, the messages in different categories using at least one of the following: different background shadows, different background colors, different font colors, different fonts or different font sizes.

15. A computer program product facilitating displaying messages based on categories related to message importance, the computer program product comprising a computer readable storage medium having program instructions embodied therewith, the program instructions executable by one or more processors to cause the one or more processors to:
receive, by the one or more processors, a request for displaying messages for a user based on categories;
calculate, by the one or more processors, an importance score of each message of the messages to the user;
classify, by the one or more processors, the messages into the categories based on calculated importance scores of the messages; and
display, by the one or more processors, the messages for the user based on the categories.

16. The computer program product of claim 15, wherein the importance score of a message is calculated based on at least one of the following: relationship between a sender of the message and the user, preferences of the user, contents of the message, properties of the message, or contexts of the message.

17. The computer program product of claim 15, wherein the displaying the messages for the user based on the categories comprises:
displaying, by one or more processors, names of the categories for the user; and
displaying, by one or more processors, messages in a category in response to detecting that the category is selected by the user.

18. The computer program product of claim 17, wherein the displaying the messages for the user based on the categories further comprises:
configuring, by one or more processors, different scrolling speeds for different categories, wherein the displaying the messages in a category in response to detecting the category is selected by the user further comprises:
scrolling, by one or more processors, the messages in the category using a configured scrolling speed of the category in response to receiving a scrolling request from the user.

19. The computer program product of claim 17, wherein the displaying the messages in a category comprises:
displaying, by one or more processors, the messages in the category in the order of the importance scores of the messages in the category.

20. The computer program product of claim 15, wherein displaying the messages for the user based on the categories comprises:
displaying, by one or more processors, the messages in different categories using at least one of the following: different background shadows, different background colors, different font colors, different fonts or different font sizes.
